(19) United States
(12) Patent Application Publication
(10) Pub. No.: US 2025/0120366 A1
(43) Pub. Date: Apr. 17, 2025

(54) Automatic pet hydration device

(71) Applicant: Randy Storey, Opa Locka, FL (US)

(72) Inventor: Randy Storey, Opa Locka, FL (US)

(21) Appl. No.: 18/445,559

(22) Filed: Oct. 17, 2023

(51) Int. Cl. A01K 7/02

(52) U.S. Cl. CPC A01K 7/027

(57) ABSTRACT

A portable device that can be temporarily attached to a building's hose spigot or plumbing angle stop valves and the like, for the purposes of: (i) providing an uninterrupted supply of cool drinking water for pets; and (ii) ongoing health monitoring via alerts of pet hydration habits. In the preferred embodiment, the device claimed herein consists of the following as illustrated in FIGS. 1, 2, 3 and 4. Housing features an internal chamber containing cooling unit, tank, control unit, inlet pipe, outlet pipe and battery. User connects anterior end of hose onto inlet pipe via inlet coupler and posterior end of hose onto a building's plumbing system using spigot coupler or angle stop valve coupler. Power cord is then connected to a wall outlet. User adjusts level sensor or float to desired depth within bowl, which establishes the maximum desired water fill level. Spigot or angle stop valve is opened to pressurize device and fill tank. The device is powered on via control pad and appropriate operational modes of control unit are selected by user. Water flowing into device through inlet pipe enters and fills tank. Cooling unit chills water in tank; water in bowl is also chilled via cooling element. Control unit opens electric valve, which allows chilled water to flow from tank to bowl via outlet pipe. Water flow into bowl ceases automatically when level sensor detects that preset fill level has been reached. When an animal down draws water in bowl below preset height of level sensor, control unit opens electric valve. Chilled water enters bowl until it contacts level sensor, thereby signaling control unit to close electric valve. User may also use control pad to activate lights for safety or decorative purposes. In an alternate embodiment, low water level in bowl lowers float and float arm, thereby opening float valve so that chilled water can flow from tank and into bowl via outlet pipe. When water lifts float to maximum fill level of bowl, float valve closes and terminates water flow. When an animal draws water below preset level, bowl is replenished automatically. In either embodiment, a constant supply of water with a temperature below ambient temperature is automatically maintained. User can use a smart device to set operational mode of control unit and monitor hydration frequency and water temperature via WIFI connection. Device can use solar panels and rechargeable batteries for primary or emergency backup power.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF THE PARTIES OF A JOINT RESEARCH AGREEMENT

Not Applicable

### REFERENCE TO SEQUENCE LISTING, A TABLE OR A COMPUTER LISTING COMPACT DISK APPENDIX

Not Applicable

### STATEMENT REGARDING PRIOR DISCLOSURES BY THE INVENTOR OR A JOINT INVENTOR

Not Applicable

### BACKGROUND OF THE INVENTION

This invention pertains to devices that provide drinking water to animals such as dogs and cats without requiring human intervention. Obtaining a continuous supply of clean water for pet hydration can present a challenge. It is difficult to maintain a consistent drinking water temperature in outdoor settings. Additionally, monitoring the physical health and habits of pets can be difficult for owners who are always not in constant proximity to the animal. Accordingly, there is a need for an improved pet drinking water delivery device which can overcome these limitations. Prior art discloses inventions intended for hydration of pets and the like. U.S. Pat. No. 4,573,434 shows a waterer that automatically refills a bowl from a bottle. It does not provide a constant water supply or the ability to control water temperature. U.S. Pat. No. 10,893,658 presents a trough filled by a constant water supply via a float valve. It is not a portable device that provides chilled water or monitoring and communication of animal hydration habits. Prior inventions do not present the plurality of novel features claimed herein such as portability, uninterrupted water supply, temperature control of water, storage of chilled water, monitoring of pet hydration, programmable and WIFI enabled user controls, illumination for safety, multiple power sources and interchangeable connection means for indoor and outdoor plumbing fixtures.

### BRIEF SUMMARY OF THE INVENTION

This invention consists of the following components as depicted in FIGS. 1 through 4. Housing 2 features internal chamber 24 containing cooling unit 6, tank 44, control unit 18, outlet pipe 8 and battery 58. Bowl 4 has a posterior face which is rigidly attached to the anterior face of housing 2. Liner 42, comprising a concave dish fabricated from an impermeable material, is affixed into the concave central section of bowl 4. Hose 28 is detachably connected at its proximal end to inlet pipe 22 via inlet coupler 26. Hose 28 is detachably connected to a plumbing water source via angle stop coupler 46 or spigot coupler 60 which can be interchangeably mounted onto distal end of hose 28. Outlet pipe 8 interconnects chamber 24 and bowl 4. Outlet pipe 8 interconnects chamber 24 and bowl 4. Device can be equipped with either an electric valve 14 or float valve 50. In either case, outlet electric valve 14 or float valve 50 is attached via watertight connection to the proximal end of outlet pipe 8. Control unit 18 is electrically connected to sensor 12, power cord 32, electric valve 14, control pad 16 and lights 38 to provide operational modes to these components. Control unit 18 contains wireless/WIFI interface and circuit which tracks and communicates operational metrics such as water temperature and water replenishment frequency. user connects hose onto a closed spigot 46 via spigot coupler 30. Power cord 32 is then connected to a wall outlet 36. User adjusts level sensor 12 or float 52 to desired depth within bowl 4, which corresponds to desired water fill level. Spigot 34 or angle stop valve 46 is opened to pressurize device and fill tank 44. The device is powered on via control pad 16 and appropriate operational modes of control unit 18 are selected by the user. Water flowing into device through inlet pipe 22 enters and fills tank 44. Cooling unit 6 chills water in tank 44 and chills water in bowl 4 via cooling element 10. Level sensor 12 opens or closes electric valve 14 to replenish water in bowl 4 to user-determined level. Alternatively, float 52 opens or closes float valve 50 to replenish water in bowl 4 to user-determined level. In either case, this process allows chilled water to automatically refill bowl 4 via outlet pipe 8 whenever an animal draws water to below the preset minimum level. User may also use control pad 16 to activate lights for safety or decorative purposes. User can use a smart device to set operational mode of control unit and monitor hydration frequency and water temperature via WIFI connection. Device can use solar panels and rechargeable batteries for primary or emergency backup power.

### BRIEF DESCRIPTION OF THE SEVERAL VIEWS OF THE DRAWING

The various features and advantages of the present technology may be more readily understood with reference to the following detailed description taken in conjunction with the accompanying drawings, wherein like reference numerals designate like structural elements.

FIG. 1 is a front view of the device.

FIG. 2 depicts a cross-sectional side view of the device.

FIG. 3 depicts a cross-sectional side view of the device with alternate float valve embodiment.

FIG. 4 depicts an exploded side view of the alternate float valve embodiment.

### DETAILED DESCRIPTION

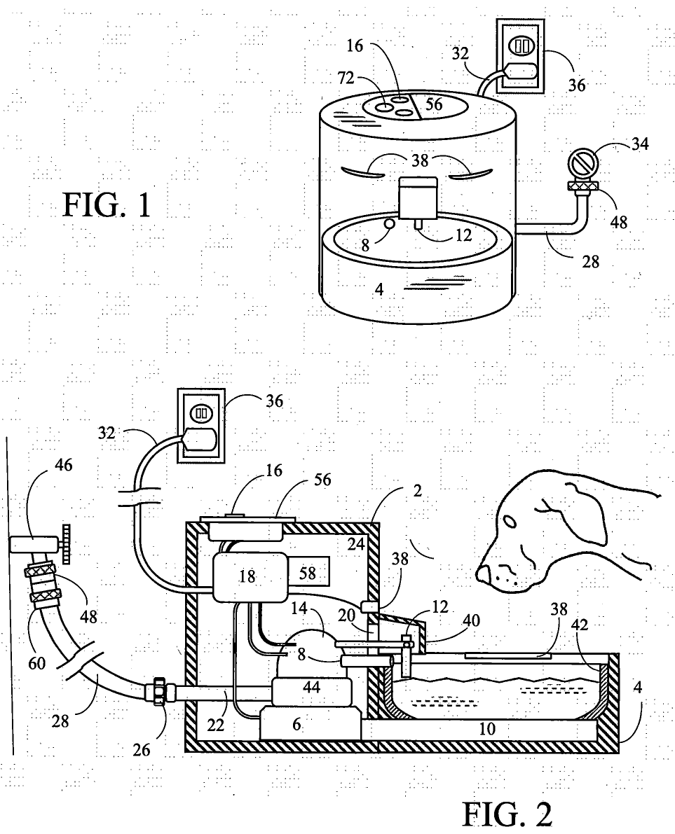

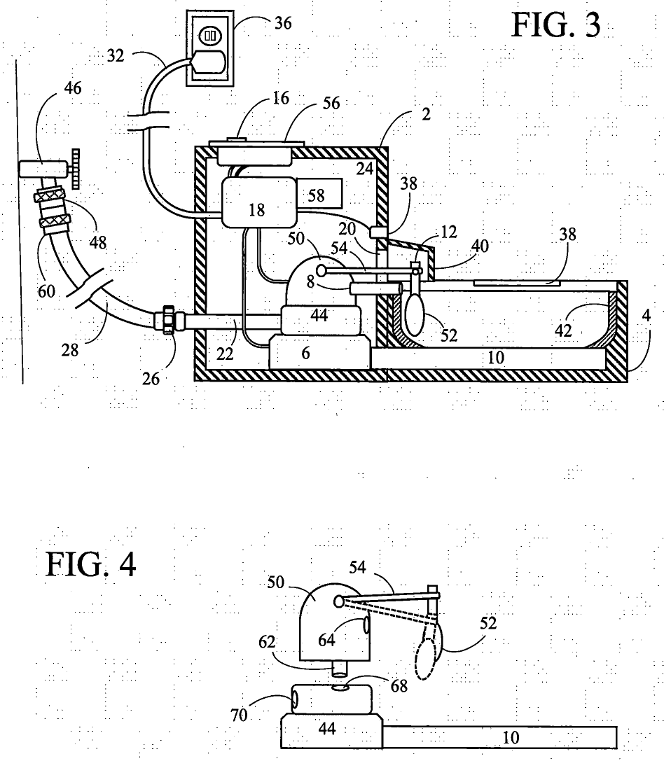

The claimed device presents a portable apparatus that can be temporarily attached to a building's interior or exterior plumbing valves, for the purposes of: (i) providing a controlled supply of drinking water for pets; and (ii) ongoing health monitoring via alerts of pet hydration habits. In the preferred embodiment, the device claimed herein consists of the following as illustrated in FIGS. 1, 2, 3 and 4.

Housing 2, fabricated from a rigid non-permeable material, features internal chamber 24 which contains cooling unit 6, tank 44, control unit 18, outlet pipe 8 and battery 58. Bowl 4, fabricated from a rigid non-permeable material, features a concave central section on its upper face and has a posterior face which is rigidly attached to the anterior face of housing 2. Liner 42, comprising a concave dish fabricated from an impermeable material, is affixed into the concave central section of bowl 4. Liner 42 of bowl 4 can be fabricated from metal to facilitate maintaining chilled temperature of drinking water. Hose 28 is detachably connected at its proximal end to inlet pipe 22 via inlet coupler 26. Hose 28 is detachably connected to a plumbing water source via angle stop coupler 46 or spigot coupler 60 which can be interchangeably mounted onto distal end of hose 28. Inlet pipe 22 has a distal end that passes through housing and connects with inlet port 70 of tank 44 via watertight connection. Outlet pipe 8 interconnects chamber 24 and bowl 4 and has a distal end that exits within bowl 4. The proximal end of outlet pipe 8 is attached via watertight connection to valve outlet port 64. Cooling unit 6 is thermally interconnected with tank 44 and cooling element 10. Control unit 18 mounted within chamber 24 is electrically connected to level sensor 12, power cord 32, electric valve 14, control pad 16 and lights 38 to provide operational modes to these components. Control unit 18 contains wireless/WIFI interface and circuit which tracks and communicates operational metrics such as water temperature and water replenishment frequency. Control unit 18 containing switches, graphic display 72 and solar panels 56 is mounted onto the exterior face of housing 2. Solar panels 56 and batteries 58 provide primary or emergency means of powering the device. Distal end of level sensor 12 is adjustable for depth within bowl 4 so that maximum water level of bowl 4 can be selected by user. Lights 38 are rigidly affixed within the outer face of housing 2 and rim of bowl 4. In an alternative embodiment, a mechanical-type float valve 50 can be installed in lieu of electric valve 14. Posterior end of float arm 54 is attached to float valve 50. Anterior end of float arm 54 extends through sensor port 20 and terminates under cover 40. Float 52 is attached to said anterior end of float arm 54 via a mounting means which allows vertical height of said float 52 relative to float arm 54 to be adjusted. In either embodiment, valve inlet port 62 of electric valve 14 or float valve 50 is attached via watertight connection to tank outlet port 68. Valve outlet port 64 is attached via watertight connection to outlet pipe 8.

To operate the device, the user connects hose 28 onto a building's closed spigot 34 via spigot coupler 60, or onto a closed angle stop valve 46 via angle stop valve coupler 48. Power cord 32 is then connected to a wall outlet 36. User adjusts level sensor 12 or float 52 to desired depth within bowl 4, which establishes the desired water fill level. The device is powered on via control pad 16 and appropriate operational modes of control unit 18 are selected by the user. User can view operational modes of via display 72. User may also use control pad 16 to activate lights 38 for safety or decorative purposes. A smart device can be used to set operational mode of control unit 18 and monitor hydration frequency and water temperature via WIFI connection. Spigot 34 or angle stop valve 46 is opened to pressurize device and fill tank 44. Water flowing into device through inlet pipe 22 enters and fills tank 44. Cooling unit chills water in tank 44 and chills water in bowl 4 via cooling element 10. Control unit 18 opens electric valve 14, which allows chilled water to flow from tank 44 to bowl 4 via outlet pipe 8. Water flow into bowl 4 ceases when level sensor 12 detects that preset fill level has been reached. Whenever an animal draws down water in bowl 4 below preset height of level sensor 12 sensing end, control unit 18 opens electric valve 14 to automatically replenish bowl 4. Chilled water enters bowl 4 until it contacts level sensor 12, thereby signaling control unit 18 to close electric valve 14. In an alternate embodiment employing manual-type float valve 50, low water level in bowl lowers float 52 and float arm 54, thereby opening float valve 50 so that chilled water can flow from tank 44 and into bowl 4 via outlet pipe 8. When water lifts float 52 to maximum fill level of bowl 4, float valve 50 closes and terminates water flow. Whenever an animal draws water below preset level, this process automatically replenishes bowl 4. In either embodiment, a constant supply of water with a temperature below ambient temperature is automatically maintained.

It is to be understood that the embodiments as described above are presented to illustrate several of the plurality of specific embodiments and configurations. For example, cooling unit 6 and cooling element 10 can employ several types of systems, such as a blower fan, semiconductor portable refrigeration or compressor type portable refrigeration. Device can be manufactured with either threaded or quick-disconnect snap inlet coupler 26, spigot coupler 30 and angle stop valve coupler 48 to provide watertight interconnection to a water supply. Moreover, the cosmetic features of housing 4 can be configured to fit specific indoor and outdoor environments. Examples include an exterior shape for placement against a wall, corner or in the middle of a room, and decorative styles such as resemblance to a fountain or waterfall. As a result, this specification is no way presented to limit the scope of configuration and function of the claimed device.

Therefore I claim:

1. A device which automatically provides hydration and monitoring hydration of animals comprising:
a housing, fabricated from a impermeable rigid material, featuring an inner chamber which contains an electric valve, level sensor, cooling unit, tank, battery and control unit rigidly affixed onto the inner surface of said chamber, and a plurality of lights affixed to the outer surface;
a bowl, fabricated from an impermeable rigid material, which is rigidly affixed onto the anterior wall of said housing and features a plurality of lights attached onto the rim and a concave central cavity which is clad with a metallic liner;
the cooling unit, which is thermally interconnected with tank and bowl, and electrically interconnected with the aforementioned control unit;
the control pad, featuring switches, display and solar panels, which is mounted onto the outer face of said housing and is electrically connected to the control unit;
the tank, which is thermally interconnected with cooling unit, and features an inlet port interconnected to an inlet pipe and an outlet port interconnected with inlet port of the electric valve;
the electric valve, featuring an outlet port terminating with an outlet pipe which projects through an aperture in the housing, and an electrical actuator means for opening and closing the valve;
a hose, which has an inlet coupler at its posterior terminal end that is removably connected to the aforementioned inlet pipe of tank, and an anterior terminal end that can be removably attached to a building's plumbing system via an interchangeable spigot coupler or stop angle valve coupler;
the level sensor comprising an elongated body which is rigidly affixed at its proximal end onto the aforementioned valve and featuring a distal sensing end which projects horizontally through the anterior face of the housing via a sensor port aperture, whereby said distal sensing end is positioned above the rim of the aforementioned bowl;
the level sensor, featuring a distal sensing end which is perpendicular to its elongated body, that can be adjusted vertically for height relative to said elongated body whereby said sensing end can be positioned at varying levels within the bowl; and
a cover, which is mounted onto the outer face of the housing so that the cover partially encloses the upper portion of the sensor port and level sensor.

2. A control unit of claim 1 which is electrically connected to the electrical components of the device, comprising:
a circuit which monitors and stores a plurality of data inputs such as frequency of refilling of the aforementioned bowl and water temperature maintained by the cooling unit;
a communications interface circuit which transmits data between control unit and the user via WIFI or the like;
a circuit which provides the user with remote control of operational modes of the control unit via WIFI or the like, and programmable control of said operational modes;
a circuit which provides control of electrical current from the aforementioned power cord, battery and solar panels, whereby battery recharging and switching between power sources is provided automatically or via user selection;
a circuit which uses input from the aforementioned level sensor to activate opening or closing of the aforementioned electric valve; and
a circuit which provides programmable or manual control over the aforementioned cooling unit and lights of the housing and bowl.

3. A float valve which can be installed in lieu of the electric valve of claim 1, comprising:
a manually actuated valve which opens and closes via upward or downward movement of a float arm with said float arm having a proximal end that is rigidly mounted onto the valve;
a buoyant float attached onto the distal end of the float arm via a mounting means which can be adjusted vertically for height relative to the proximal end said float arm, whereby said float can be positioned at varying levels within the aforementioned bowl; and
an electrical connection with the aforementioned control unit which allows duty cycle of the float valve to be monitored.
